(19) United States
(12) Patent Application Publication
(10) Pub. No.: US 2006/0146160 A1
(43) Pub. Date: Jul. 6, 2006

(54) Imaging device, driving device, digital camera and imaging method

(75) Inventors: Masashi Murakami, Souraku-gun (JP); Masayuki Masuyama, Nagaokakyo-shi (JP); Yoshiyuki Matsunaga, Kamakura-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/294,333

(22) Filed: Dec. 6, 2005

(30) Foreign Application Priority Data
Dec. 8, 2004 (JP) JP 2004-355858

(51) Int. Cl. H04N 5/335

(52) U.S. Cl. 348/308

(57) ABSTRACT

A digital camera 100 includes an imaging device having a plurality of unit cells, each generating and accumulating therein a piece of luminance information in accordance with an amount of received light. The imaging device comprises: a receiving unit 103 operable to receive a shooting instruction from outside; an all-reset unit 104 operable to simultaneously reset all the unit cells in response to the shooting instruction while a light-shielding gate is open; a light-shielding unit 101 operable to close the light-shielding gate to simultaneously block light incident on all the unit cells when, after the all-reset unit resets all the unit cells, a total length of periods for which the light-shielding gate has been open reaches an exposure time; and a reading unit 105 operable to sequentially read pieces of the luminance information from all the unit cells while the light-shielding gate is closed.

### BACKGROUND OF THE INVENTION

(1) Field of the Invention

The present invention relates to an imaging device including unit cells, which are one-dimensionally or two-dimensionally disposed on a substrate and subject incident light to photoelectric conversion. The present invention particularly relates to a technique to prevent a distortion of an image of a moving subject.

(2) Description of the Related Art

In recent years, imaging apparatuses, such as portable phones having a digital camera function, have been widely spread. In such apparatuses, it is necessary to save power consumption to save weight and extend the use time in the case of continuous use. Therefore, MOS type imaging devices, which consume significantly lower power than the CCD type imaging devices, are often used in such apparatuses.

In conventional MOS type imaging devices, electric charges are read from each line, and an exposure timing might be different for each line. Accordingly, the taken image might be distorted due to the motion of a subject.

Patent Document 1 (Japanese Laid-open Patent Application NO. 2004-64558) discloses an imaging device that overcomes such a fault. This document asserts that high-quality images can be obtained by the disclosed imaging device.

However, this imaging device can merely reduce the distortion of the image, which is caused by the difference of exposure timing among lines, to the extent that it is imperceptible to human-eye, and can not eliminate the distortion completely. Also, this technique is developed for the case of shooting moving pictures, and it can not gain a sufficient effect in the case of shooting still pictures.

Further, to structure a peripheral circuit by a single channel MOS, a dynamic circuit is often used. If this is the case, the circuit is liable to malfunction due to the floating status. Therefore, to reset all the unit cells at the same time by an electronic shutter to adjust the exposure start timing, some measures need to be taken.

### SUMMARY OF THE INVENTION

The object of the present invention is therefore to provide an imaging device having different exposure timings, but capable of completely eliminating a distortion of an image due to the difference of the exposure timings and preventing misoperation of a dynamic circuit using a single channel MOS.

The above object is fulfilled by an imaging device having a plurality of unit cells, each generating and accumulating therein a piece of luminance information in accordance with an amount of received light, the imaging device comprising: a receiving unit operable to receive a shooting instruction from outside; an all-reset unit operable to simultaneously reset all the unit cells in response to the shooting instruction while a light-shielding gate is open; a light-shielding unit operable to close the light-shielding gate to simultaneously block light incident on all the unit cells when, after the all-reset unit resets all the unit cells, a total length of periods for which the light-shielding gate has been open reaches an exposure time; and a reading unit operable to sequentially read pieces of the luminance information from all the unit cells while the light-shielding gate is closed.

The light-shielding unit may close the light-shielding gate at a time determined independently of a change of the exposure time, and the all-reset unit may adjust a timing with which the all-reset unit resets all the unit cells, in accordance with the change of the exposure time.

The imaging device may further comprise: a monitor unit operable, before the shooting instruction is received by the receiving unit, to display moving pictures by continuously reading the pieces of the luminance information while the light-shielding gate is open, and when the shooting instruction is received, to stop a pixel reset operation and a luminance information reading operation, which are performed every time the luminance information is read, at least until the reading unit finishes reading the pieces of the luminance information.

The monitor unit may apply a pixel reset signal and a luminance information reading signal to read the pieces of the luminance information, and stop applying the pixel reset signal and the luminance information reading signal at least during a period between when the all-reset unit resets all the unit cells and when the light-shielding unit blocks the light.

The monitor unit may include a shift register operable to sequentially generate the pixel reset signal and the luminance information reading signal for each column of the imaging device, and may stop an operation of the shift register at least during the period between when the all-reset unit resets all the unit cells and when the light-shielding unit blocks the light.

The shift register may sequentially generate the pixel reset signal and the luminance information reading signal for each column of the imaging device while sequentially shifting a target column to which a start pulse is provided for each frame, and the monitor unit may stop the start pulse in response to the shooting instruction at least until when the light-shielding unit blocks the light.

The all-reset unit may simultaneously reset all the unit cells in a period between when the shift register finishes generating the pixel reset signal and the luminance information reading signal for each column and when the light-shielding unit blocks the light.

To read the pieces of the luminance information, the monitor unit may apply a first pixel reset pulse used for an electronic shutter, a first pixel reading pulse used for the electronic shutter, a second pixel reset pulse used for reading image signals and a second pixel reading pulse used for reading image signals, and may stop applying the first pixel reading pulse and the second pixel reading pulse at least during a period between when the all-reset unit resets all the unit cells and when the light-shielding unit blocks the light.

To read the pieces of the luminance information, the monitor unit may apply a first pixel reset pulse used for an electronic shutter, a first pixel reading pulse used for the electronic shutter, a second pixel reset pulse used for reading image signals and a second pixel reading pulse used for reading image signals, and may stop applying the first pixel reset pulse, the first pixel reading pulse, the second pixel reset pulse and the second pixel reading pulse at least during a period between when the all-reset unit resets all the unit cells and when the light-shielding unit blocks the light.

To read the pieces of the luminance information, the monitor unit may apply a pixel reset pulse used for an electronic shutter and a pixel reading pulse used for the electronic shutter, and may stop applying the pixel reading pulse during a period between when the all-reset unit resets all the unit cells and when the reading unit finishes reading the pieces of the luminance information.

To read the pieces of the luminance information, the monitor unit may apply a pixel reset pulse used for an electronic shutter and a pixel reading pulse used for the electronic shutter, and may stop applying the pixel reset pulse and the pixel reading pulse during a period between when the all-reset unit resets all the unit cells and when the reading unit finishes reading the pieces of the luminance information.

The monitor unit may include a shift register operable to sequentially generate the pixel reset signal for each column of the imaging device, and may stop an operation of the shift register during a period between when the all-reset unit resets all the unit cells and when the reading unit finishes reading the pieces of the luminance information.

The shift register may sequentially generate the pixel reset signal for each column of the imaging device while sequentially shifting a target column to which a start pulse is provided for each frame, and the monitor unit may stop the start pulse in response to the shooting instruction until the reading unit finishes reading the pieces of the luminance information.

The imaging device may further comprise: a unit cell driving circuit operable to generate a pulse used for driving the unit cells, based on a signal provided by the all-reset unit to reset all the unit cells and a signal provided by the monitor unit to perform the pixel reset operation, and provide each of the unit cells with the generated pulse, and each of the shift register and the selection circuit may be structured by a dynamic circuit using a single channel MOS.

The all-reset unit may reset all the unit cells at any time in one cycle of a horizontal scanning, regardless of whether the time is within a horizontal blanking period.

The above object is also fulfilled by a driving device that provides control signals to an imaging device having a plurality of unit cells, each outputting a piece of luminance information in accordance with an amount of received light, the driving device comprising: a waiting unit operable to wait for a shooting instruction to be input from outside; an all-reset control signal outputting unit operable to output an all-reset control signal to simultaneously reset all the unit cells in response to the shooting instruction while a light-shielding gate is open; a closing control signal outputting unit operable to output a light-shielding gate closing control signal to close the light-shielding gate that blocks light incident on all the unit cells when, after the all-reset unit resets all the unit cells, a total length of periods for which the light-shielding gate has been open reaches an exposure time; and a reading control signal outputting unit operable to output a reading control signal to sequentially read the pieces of the luminance information from all the unit cells while the light-shielding gate is closed.

The above object is also fulfilled by an imaging method for controlling an imaging device having a plurality of unit cells, each outputting a piece of luminance information in accordance with an amount of received light, the imaging method comprising: a receiving step of receiving a shooting instruction from outside; an all-reset step of simultaneously resetting all the unit cells in response to the shooting instruction while a light-shielding gate is open; a light-shielding step of closing the light-shielding gate to simultaneously block light incident on all the unit cells when, after the all-reset unit resets all the unit cells, a total length of periods for which the light-shielding gate has been open reaches an exposure time; and a reading step of sequentially reading pieces of the luminance information from all the unit cells while the light-shielding gate is closed.

With the stated structure, although the luminance information is not read from all the unit cells at the same time, it becomes possible to completely synchronize the exposure timings of all the unit cells. This is because all the unit cells are reset at the same time by the electronic shutter, and the light incident on all the unit cells is blocked at the same time by the light-shielding gate, such as a mechanical shutter. Accordingly, the present invention is capable of completely eliminating a distortion of an image caused due to the difference of the exposure timings, and capable of gaining high-quality still pictures.

Also, the present invention is capable of adjusting the exposure time by just changing the reset timing of the electronic shutter while the closing timing of the light-shielding gate is fixed. Therefore, it becomes easy to control and adjust the exposure time accurately.

Also, in the case where the pixel reading pulse used for the electronic shutter (ETRANS) and the pixel reading pulse used for reading image signals (TRANS) are not applied, the exposure time of all the pixels can be the same. Even if the SR output used for reading, or the SR output used for the electronic shutter misoperates in the dynamic circuit structured by the signal channel MOS, TROUT can be kept at “LOW”. This is very effective for the prevention of misoperations of the imaging device.

Also, in the case where the pixel reset pulse used for the electronic shutter (ERSCELL) and the pixel reset pulse used for reading image signals (RSCELL) are not applied, the present invention is capable of suppressing a leak caused due to change in potential in a floating fusion unit (an FD unit) from which to read the luminance information. Even if the SR output used for reading, or the SR output used for the electronic shutter misoperates in the dynamic circuit structured by the single channel MOS, TROUT can be kept at “LOW”. This is very effective for the prevention of misoperations of the imaging device.

Further, in the case of stopping the pixel reset pulse used for the electronic shutter (ERSCELL) to record still pictures, the all-reset unit 104 can reset the pixels at any time in one cycle of the horizontal scanning, regardless of whether the time is within the horizontal blanking period. Accordingly, the present invention is capable of flexibly controlling the application of the pulses.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows a digital camera 100 according to the first embodiment of the present invention;

FIG. 2 schematically shows a structure of a solid-state imaging device;

FIG. 3 schematically shows a structure of circuits included in a pixel group 1;

FIG. 4 schematically shows a circuit structure of a unit register included in a shift register 2 used for an electronic shutter;

FIG. 5 is a timing chart for operations of a shift register 2 used for an electronic shutter;

FIG. 6 shows a logical circuit of a first stage included in a multiplexer circuit 4;

FIG. 7 schematically shows a circuit structure of a first stage included in a multiplexer circuit 4;

FIG. 8 shows a functional structure of a digital camera 100 according to the first embodiment of the present invention;

FIG. 9 shows a processing procedure performed by a digital camera 100 according to the first embodiment to take a still picture;

FIG. 10 is an example timing chart for control pulses and so on used in a digital camera 100 according to the first embodiment;

FIG. 11 is another example timing chart for control pulses and so on used in a digital camera 100 according to the first embodiment;

FIG. 12 is another example timing chart for control pulses and so on used in a digital camera 100 according to the first embodiment;

FIG. 13 shows a processing procedure performed to take a still picture according to the first modification of the present invention;

FIG. 14 is a timing chart for control pulses and so on according to the first modification;

FIG. 15 shows a processing procedure performed to take a still picture according to the second modification;

FIG. 16 is a timing chart for control pulses and so on according to the second modification; and

FIG. 17 is a timing chart for an all-reset pulse and so on according to the third modification.

### DESCRIPTION OF THE PREFERRED EMBODIMENT

### The First Embodiment

<Overview>

The first embodiment of the present invention uses an electronic shutter and a mechanical shutter together. Although not able to read luminance information from all the unit cells at the same time, this embodiment can exactly synchronize exposure timings of all the unit cells to completely eliminate distortion of an image. Also, this embodiment easily and accurately controls the exposure time.

<Structure>

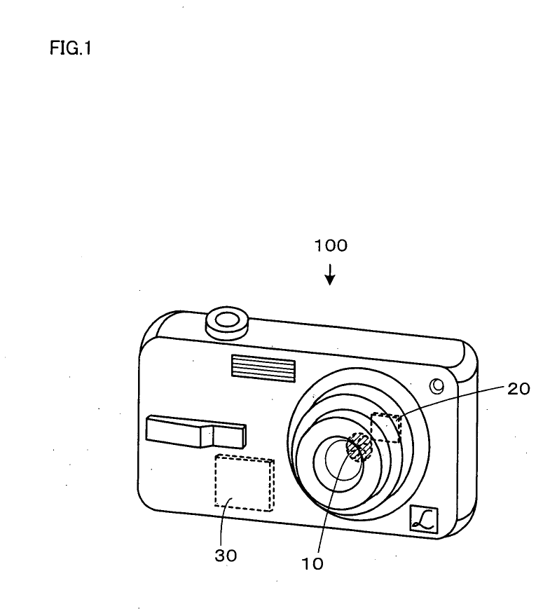

FIG. 1 shows a digital camera 100 according to the first embodiment of the present invention.

As FIG. 1 shows, the digital camera 100 according to the first embodiment is an imaging apparatus that is capable of taking still pictures while displaying moving pictures on a display panel, such as an LCD (not illustrated). The digital camera 100 includes a light-shielding device 10, a solid-state imaging device 20 and a drive control device 30.

The light-shielding device 10 is a mechanical shutter or the like, and disposed in a light path behind a lens for instance. The light-shielding device 10 is an openable and closable light-shielding gate which blocks light using a light-shielding plate when it is in a closed status, and gets through light when it is in an opened status. The light-shielding device 10 can synchronously get through light entering the unit cells on the solid-state imaging device 20 (by changing the status from the closed status to the opened status), and block the light (by changing the status from the opened status to the closed status) in accordance with a control signal input from the drive control device 30.

Here, note that the light-shielding device is not limited to a mechanical shutter. It is possible to replace the mechanical shutter with any other mechanism as long as it can block light in the closed status and get through light in the opened status.

The solid-state imaging device 20 includes a semiconductor device and peripheral circuits. A plurality of unit cells, each of which outputs luminance information in accordance with the amount of received light, are arranged in the semiconductor device. The solid-state imaging device 20 is disposed where an image is formed by the light passing through the light-shielding device 10.

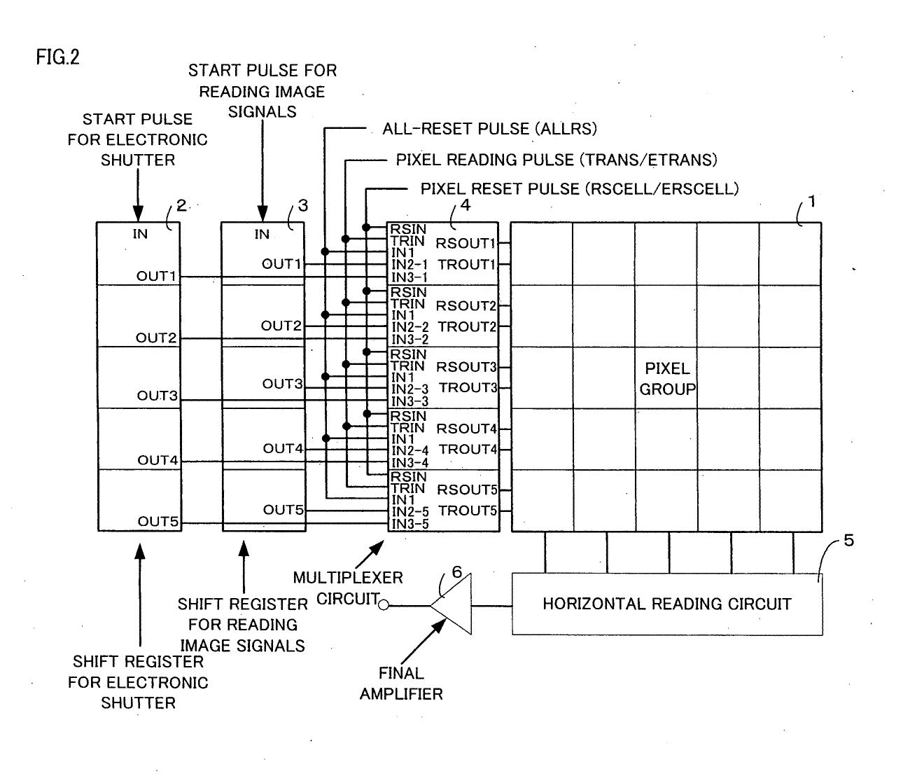

FIG. 2 schematically shows a structure of the solid-state imaging device 20 according to the first embodiment of the present invention.

As FIG. 2 shows, the solid-state imaging device 20 according to the first embodiment of the present invention includes pixel group 1, a shift register 2 used for an electronic shutter, a shift register 3 used for reading image signals, a multiplexer circuit 4, a horizontal reading circuit 5, and a final amplifier 6.

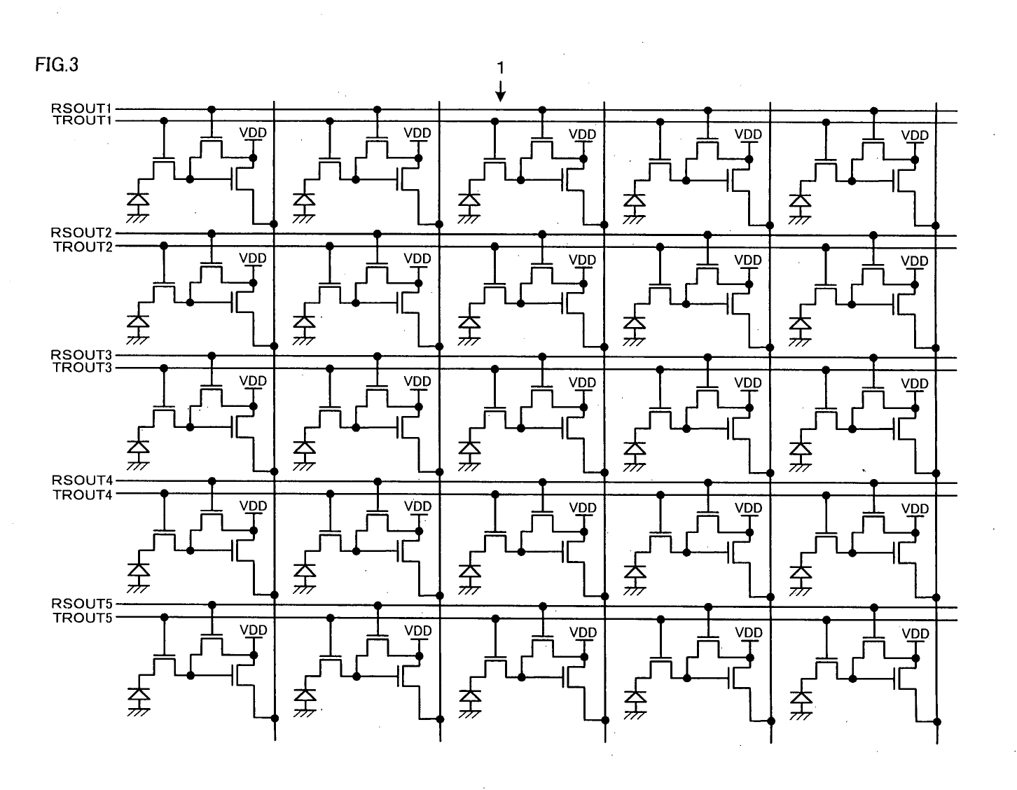

FIG. 3 schematically shows the structure of the circuits included in the pixel group 1.

The pixel group 1 constitutes an imaging region in which unit cells are one-dimensionally or two dimensionally disposed. In FIG. 2 and FIG. 3, only twenty five unit cells, which are two-dimensionally disposed in a 5×5 matrix shape, are illustrated for simplification. However, the actual number of the unit cells is hundreds to thousands in the case of the one-dimension arrangement, and hundreds of thousands to millions in the case of the two-dimension arrangement.

The shift register 2 used for the electronic shutter sequentially shifts a target column to which the start pulse used for the electronic shutter is provided by the drive control device 30 for each frame, and thereby sequentially generates column address signals used for the electronic shutter, to read the luminance information and record moving pictures.

The shift register 3 used for reading image signals sequentially shifts a target column to which the start pulse used for reading image signals is provided by the drive control device 30 for each frame, and thereby sequentially generate column address signals used for reading image signals, to read the luminance information and record moving pictures and still pictures.

If the user presses the shutter button to give an instruction to record a still picture, the drive control device 30 stops the start pulse used for the electronic shutter, which is provided to the shift register 2 used for the electronic shutter, and stops the start pulse used for reading image signals, which is provided to the shift register 3 used for reading image signals. As a result, the drive control device 30 stops the generation of the column addresses used for the electronic shutter and the column addresses used for reading image signals, and deactivates a moving pictures displaying function.

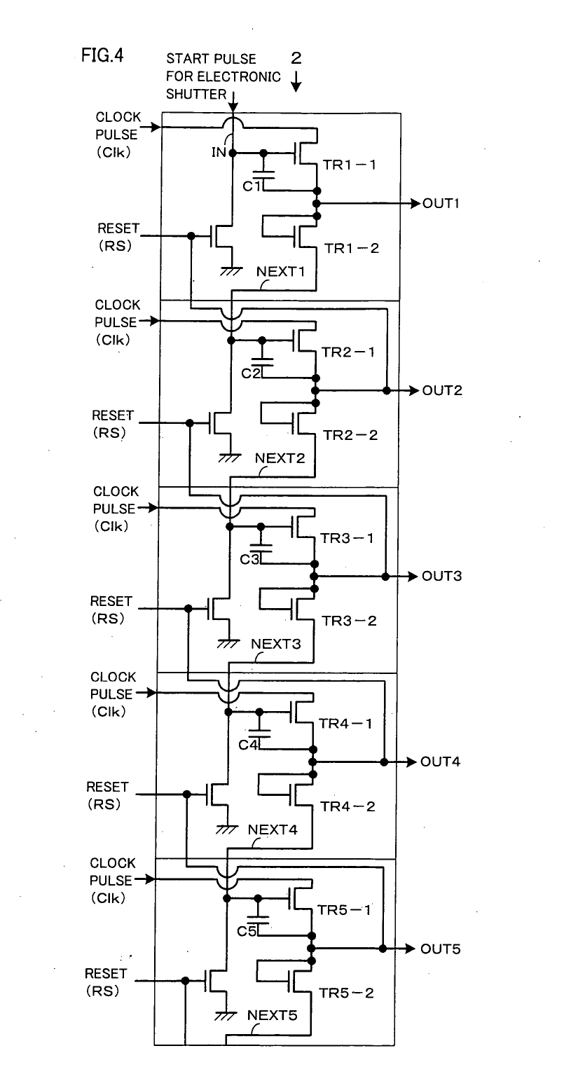

FIG. 4 schematically shows a circuit structure of a unit register included in the shift register 2 used for the electronic shutter. Although only five stages are illustrated in FIG. 4, the actual number of the stages is the same as the number of columns included in the pixel group 1, which is hundreds to thousands.

As FIG. 4 shows, the shift register 2 used for the electronic shutter is structured by a dynamic circuit using a single channel MOS.

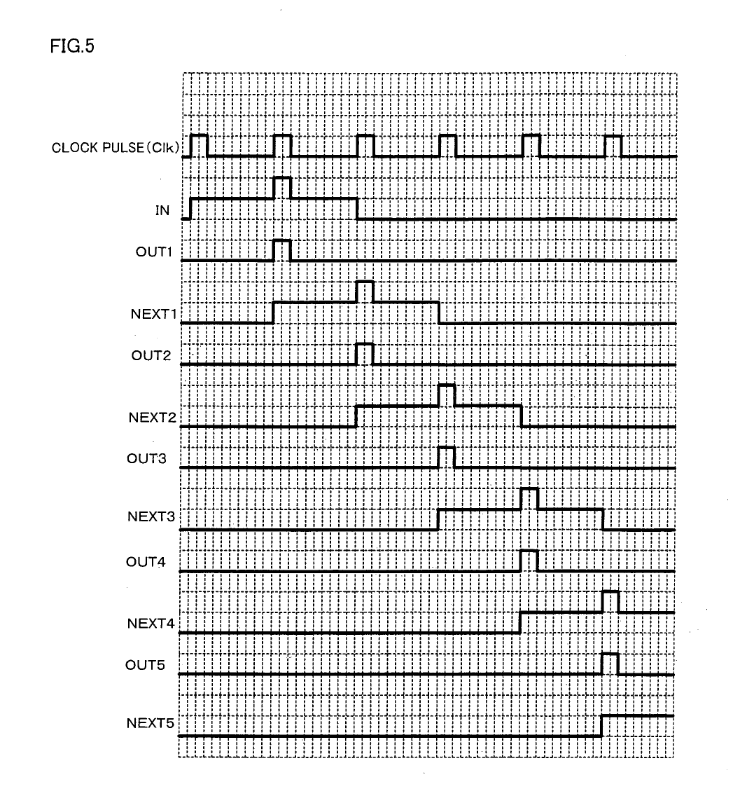

FIG. 5 is a timing chart for operations of the shift register 2 used for the electronic shutter.

The following describe the operations performed by the shift register 2 used for the electronic shutter.

When the start pulse used for the electronic shutter becomes “High” and the clock pulse (Clk) changes from “Low” to “High”, the capacitor C1 boosts up the gate voltage of the TR1-1 (IN).

Due to the high voltage applied to the gate of the TR1-1, the “High” voltage of the clock pulse (Clk) is output to OUT1. Also as a high voltage is also applied to the gate of the TR1-2, the “High” voltage is output to the NEXT1.

Then, when the clock pulse (Clk) changes from “High” to “Low”, the “Low” voltage of the clock pulse (Clk) is output to the OUT1, while the NEXT 1 keeps the “High”-voltage because the TR-1-2 is a unidirectional device.

After that, the above-described operations are repeated for each clock pulse (Clk) in the order from the second stage to the fifth stage, and voltages are sequentially output to the OUT1 to the OUT5.

The circuit structure and the operations of the shift register 3 used for reading image signals are the same as the shift register 2 used for the electronic shutter. Therefore, their descriptions are omitted here.

The multiplexer circuit 4 is a logical circuit that generates pulses used for driving unit cells based on the all-reset pulse (ALLRS) and the SR output used for the electronic shutter, and provides the pulses to the unit cells in column-by-column manner.

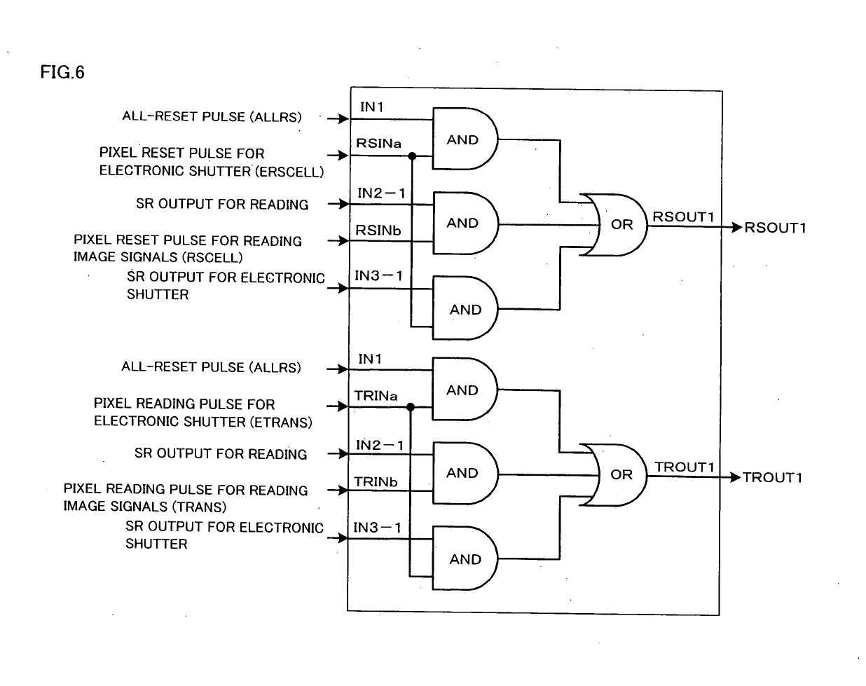

FIG. 6 shows a logical circuit of a first stage included in the multiplexer circuit 4.

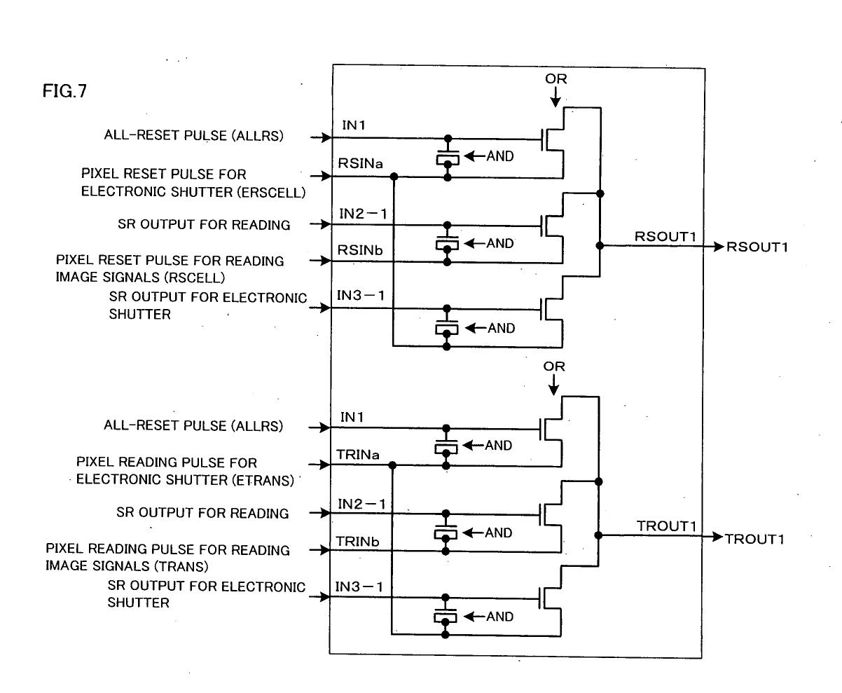

FIG. 7 schematically shows a circuit structure of the first stage included in the multiplexer circuit 4.

As FIG. 7 shows, the multiplexer circuit 4 is structured by a dynamic circuit using a single channel MOS.

According to the multiplexer circuit 4 shown in FIG. 6 and FIG. 7, the RSOUT 1 is output (i) when the all-reset pulse (ALLRS) and a pixel reset pulse used for the electronic shutter (ERSCELL) are output at the same time, (ii) when the SR output used for reading and a pixel reset pulse used for reading image signals (RSCELL) are output at the same time, and (iii) when the SR output used for the electronic shutter and the pixel reset pulse used for the electronic shutter (ERSCELL) are output at the same time. Also, the TROUT 1 is output (i) when the all-reset pulse (ALLRS) and a pixel reading pulse used for the electronic shutter (ETRANS) are output at the same time, (ii) when the SR output used for reading and the pixel reading pulse used for the electronic shutter (ETRANS) are output at the same time, and (iii) when the SR output used for the electronic shutter and the pixel reading pulse used for the electronic shutter (ETRANS) are output at the same time.

The circuits at the second to fifth stages in the multiplexer circuit are the same as the circuit at the first stage.

The drive control unit 30 includes a semiconductor device and the peripheral circuit, and provides a control signal to the solid-state imaging device 20 to drive and control the solid-state imaging device 20. The drive control unit 30 waits for a shooting instruction to be input. Upon receiving the shooting instruction, the drive control unit 30 outputs the all-reset pulse (ALLRS) which resets all the pieces of the luminance information stored in unit cells while the light-shielding gate is open. When the total length of periods for which the light-shielding gate has been open reaches the exposure time, the drive control unit 30 closes the light-shielding gate and outputs a gate closing control signal used for blocking light incident on all the unit cells. After closing the light-shielding gate, the drive control unit 30 outputs a reading control signal used for sequentially reading the luminance information from all the unit cells.

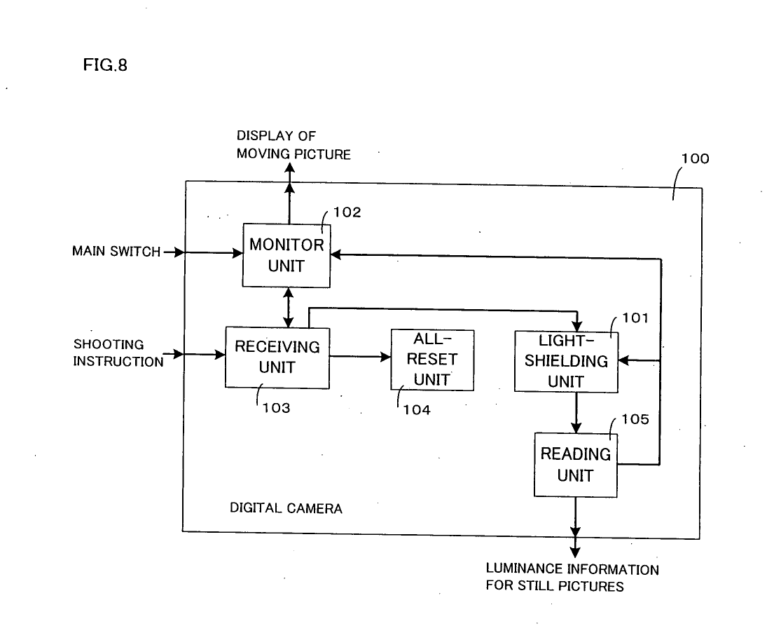

FIG. 8 shows a functional structure of the digital camera 100 according to the first embodiment of the present invention.

As FIG. 8 shows, the digital camera 100 includes a light-shielding unit 101, a monitor unit 102, a receiving unit 103, an all-reset unit 104, and a reading unit 105.

The structure of the light-shielding unit 101 is the same as the structure of the light-shielding device 10.

If the main switch has been pressed, before the receiving unit 103 receives the shooting instruction, the monitor unit 102 sequentially reads pieces of the luminance information and displays moving pictures, while the light-shielding gate of the light-shielding unit 101 is open. If the receiving unit 103 receives the shooting instruction while the monitor unit 102 displays the moving pictures, the monitor unit 103 suspends the display of the moving pictures at least until the reading unit 105 finishes reading the luminance information.

The receiving unit 103 waits for an input of a shooting instruction, which is generated when the shutter button is pressed by the user for instance and input from outside the imaging device. Upon receiving the shooting instruction, the receiving unit 103 instructs the monitor unit 102 to suspend the display of the moving pictures, and instructs other units to start shooting a still picture in synchronization with the operation of the monitor unit 102.

If the receiving unit 103 receives the shooting instruction, the all-reset unit 104 resets all the pieces of the luminance information stored in the unit cells, while the light-shielding gate of the light-shielding unit 101 is open.

The all-reset unit 104 obtains an exposure time by, for instance, obtaining the image signals used for displaying the moving picture, receiving a manual setting from the user, or measuring an amount of light reflected from a subject using a photometer sensor. Then, the all-reset unit 104 changes the reset timing according to the obtained exposure time, and adjusts the exposure time.

After the all-reset unit 104 resets the luminance information, the light-shielding unit 101 closes the light-shielding gate in accordance with the shooting instruction received by the receiving unit 103, while the light-shielding gate is open. Here, the time when light-shielding gate is closed is not related to the change of the exposure time. As a result, the light-shielding unit 101 closes the light-shielding gate when the exposure time is elapsed, and blocks the light incident on all the unit cells at the same time.

After the light-shielding unit 101 closes the light-shielding gate, the reading unit 105 sequentially reads the pieces of the luminance information for still pictures from the unit cells, while the light-shielding gate is closed.

After the reading unit 105 finishes reading the luminance information for still pictures, the light-shielding unit 101 opens the light-shielding gate, and prepares for the restart of the operation for displaying moving pictures, which is performed by the monitor unit 102.

After the luminance information for still pictures is read and the light-shielding unit is closed, the monitor unit 102 restarts the operation for displaying moving pictures.

<Operations>

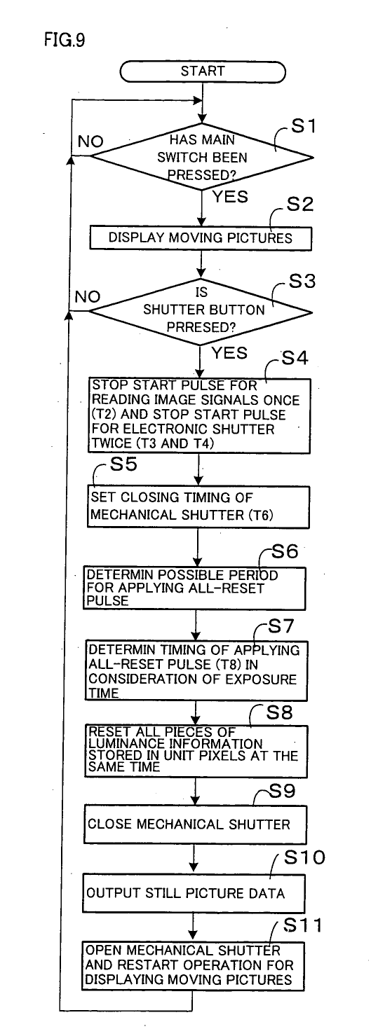

FIG. 9 shows a processing procedure performed by the digital camera 100 according to the first embodiment to take a still picture.

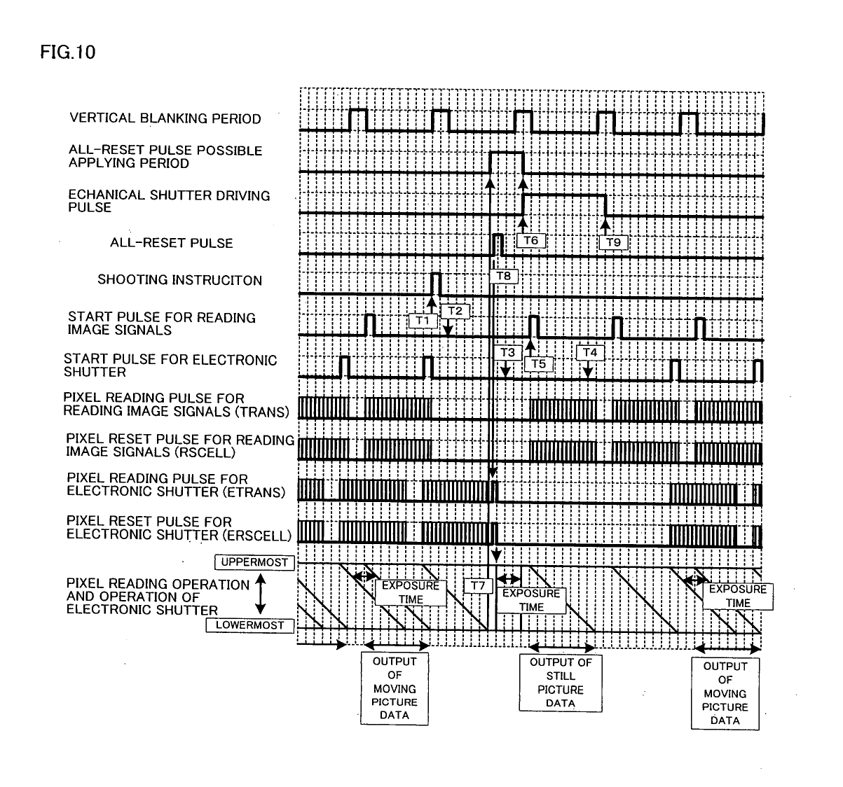

FIG. 10 is an example timing chart for control pulses and so on used in the digital camera 100 according to the first embodiment.

The following describes the processing procedure for taking a still picture with reference to FIG. 9 and FIG. 10.

(1) The drive control device 30 judges whether the main switch has been pressed (Step S1).

Here, assume that the light-shielding gate (a mechanical shutter) of the light-shielding unit 101 has been open in the stopped state before the main switch is pressed.

(2) If the main switch has been pressed, the state is changed to the moving pictures displaying state (state in the period before the time T1 in FIG. 10), and the monitor unit 102 sequentially reads pieces of the luminance information and display the luminance information as moving pictures, while the mechanical shutter is open (Step S2).

(3) While the state is moving picture displaying state, the receiving unit 103 waits for the shooting instruction (T1) (Step S3). Here, assume that the receiving unit 103 waits for the shutter button to be pressed.

(4) If the shutter button is pressed by the user, the receiving unit 103 instructs the monitor unit 102 to stop operations for displaying moving pictures. The monitor unit 102 stops the start pulse used for reading image signals once (T2) after the shutter button is pressed, and then stops the start pulse used for the electronic shutter twice (T3 and T4) (Step S4).

(5) The receiving unit 103 sets T6 as a time at which the mechanical shutter is closed. T6 is a little before T5 at which the start pulse used for reading image signals is restarted (Step S5).

(6) The receiving unit 103 sets T7 as a possible start point of the all-reset pulse. T7 is a time at which the operation of the mechanical shutter in accordance with the start pulse used for the electronic shutter finishes. Then, the receiving unit 103 sets T6 as a possible end point of the application of the all-reset pulse. T6 is a time at which the mechanical shutter is closed (Step-S6).

(7) The receiving unit 103 determines the application timing of the all-reset pulse (T8) based on the possible end point, with consideration of the exposure time (Step S7).

(8) The all-reset unit 104 applies the all-reset pulse at T8 in accordance with the decision by the receiving unit 103, to reset all the pieces of the luminance information stored in the unit cells at the same time (Step S8).

(9) The drive control unit 30 applies the mechanical shutter driving pulse at T6 in accordance with the decision by the receiving unit 103, and the light-shielding unit 101 closes the mechanical shutter (Step S9).

(10) The drive control unit 30 applies the start pulse used for reading image signals at T5, and still picture data is output (Step S10).

(11) As the still picture data is output, the drive control unit 30 stops the mechanical shutter driving pulse (T9). Accordingly, the light-shielding unit 101 opens the mechanical shutter. Then, the operation for displaying moving pictures is restarted (Step S11).

Note that the exposure time should be the same for each pixel during the period from the time when the all-reset unit 104 resets all the pieces of the luminance information stored in unit cells to the time when the light-shielding unit 101 closes mechanical shutter. Accordingly, TROUT should be kept at “Low” during the above-described period.

To keep TROUT at “LOW”, two methods can be used. The first method is to stop the pixel reading pulse used for the electronic shutter (ETRANS) and the pixel reading pulse used for reading image signals (TRANS). The second method is to stop the SR output used for reading and the SR output used for the electronic shutter. (Here, “to stop the pulse” means “to keep the pulse at LOW”.) If the shift register is structured by a single channel MOS, a dynamic circuit is often used, and if this is the case, misoperation tends to occur due to the floating status. In this case, the first method, which stops the pixel reading pulse used for the electronic shutter (ETRANS) and the pixel reading pulse used for reading image signals (TRANS), is very effective, because the TROUT can be kept at “LOW” even if the SR output used for reading and the SR output used for the electronic shutter cause misoperation.

Also, to suppress a leak caused due to change in potential in a floating fusion unit (an FD unit), from which to read the luminance information, it is preferable to keep the RSOUT at “LOW” during the exposure.

Here, to keep the RSOUT at “LOW” two methods can be used. The first method is to stop the pixel reset pulse used for the electronic shutter (ERSCELL) and the pixel reset pulse used for reading image signals (RSCELL). The second method is to stop the SR output used for reading and the SR output used for the electronic shutter. (Here, “to stop the pulse” means “to keep the pulse at LOW”.)

For the same reason as in the case of the TROUT, the first method, which stops the pixel reset pulse used for the electronic shutter (ERSCELL) and the pixel reset pulse used for reading image signals (RSCELL), is very effective.

At the still picture shooting, in the case of not stopping the pixel reset pulse used for the electronic shutter (ERSCELL), the all-reset unit 104 should not apply the pixel reset pulse used for the electronic shutter (ERSCELL) during the horizontal blanking period to prevent conflict with the ERSCELL for moving picture. However, in the case of stopping the pixel reset pulse used for the electronic shutter (ERSCELL), the all-reset unit 104 can apply the pixel reset pulse used for the electronic shutter (ERSCELL) at any time in one cycle of the horizontal scanning, regardless of whether the time is within the horizontal blanking period. Therefore, it is preferable to stop the pixel reset pulse used for the electronic shutter (ERSCELL).

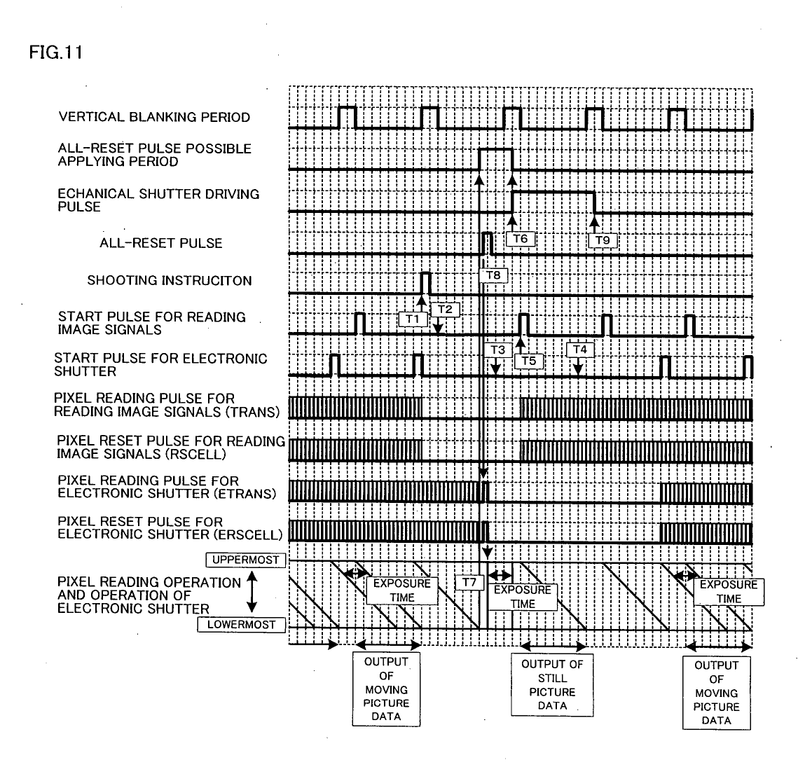

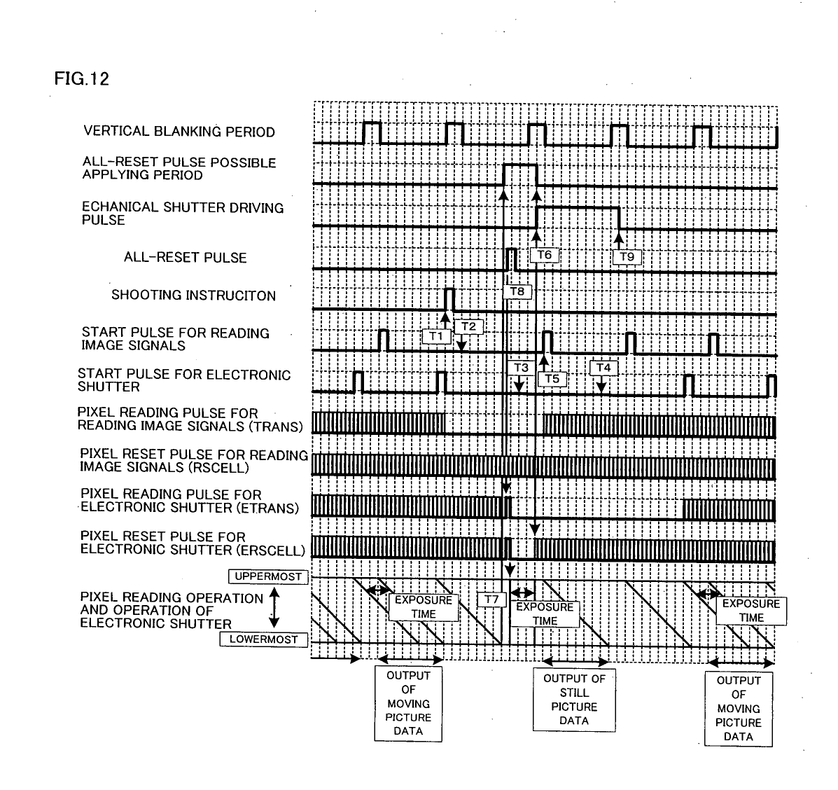

FIG. 11 and FIG. 12 are example timing charts for control pulses and so on used in the digital camera 100 according to the first embodiment. FIG. 11 is different from FIG. 10 in that the pixel reading pulse used for reading image signals (TRANS), the pixel reset pulse used for reading image signals (RSCELL), the pixel reading pulse used for the electronic shutter (ETRANS) and the pixel reset pulse used for the electronic shutter (ERSCELL) are applied during the horizontal blanking period as well.

As FIG. 11 shows, the pixel reading pulse used for reading image signals (TRANS), the pixel reset pulse used for reading image signals (RSCELL), the pixel reading pulse used for the electronic shutter (ETRANS) and the pixel reset pulse used for the electronic shutter (ERSCELL) may be applied during the horizontal blanking period as well.

FIG. 12 is different from FIG. 11 in that, at the still picture shooting, only the pixel reading pulse used for the image signals (TRANS) and the pixel reading pulse used for the electronic shutter (ETRANS) are stopped, and the pixel reset pulse used for the electronic shutter (ERSCELL) is stopped only during the resetting period of the all reset unit 104.

AS FIG. 12 shows, it is not necessary to stop the pixel reset pulse used for reading image signals (RSCELL). The pixel reset pulse used for the electronic shutter (ERSCELL) should be stopped at least during the resetting period.

The ideal application timing of the control pulses and so on is the timing illustrated in FIG. 10. However, the timing illustrated in FIG. 11 has the advantage that it can simplify the control, and the timing illustrated in FIG. 12 can further simplify the control. Therefore, it is possible to use any of them according to the purpose.

<Summary>

As described above, according to the first embodiment of the present invention, although the pieces of the luminance information are read from the unit cells at different times, all the unit cells are exposed exactly at the same time.

Accordingly, the present invention is capable of preventing a distortion of an image caused due to the difference of the exposure timing. In particular, the present invention can obtain a high-quality image at the still picture shooting.

Also, the first embodiment of the present invention is capable of preventing misoperation of a dynamic circuit using a single channel MOS.

The First Modification

<Overview>

The first modification of the present invention is an example in which the display of the moving pictures is stopped for a longer period than the first embodiment, and accordingly the exposure time for a still picture is longer than the first embodiment.

<Operations>

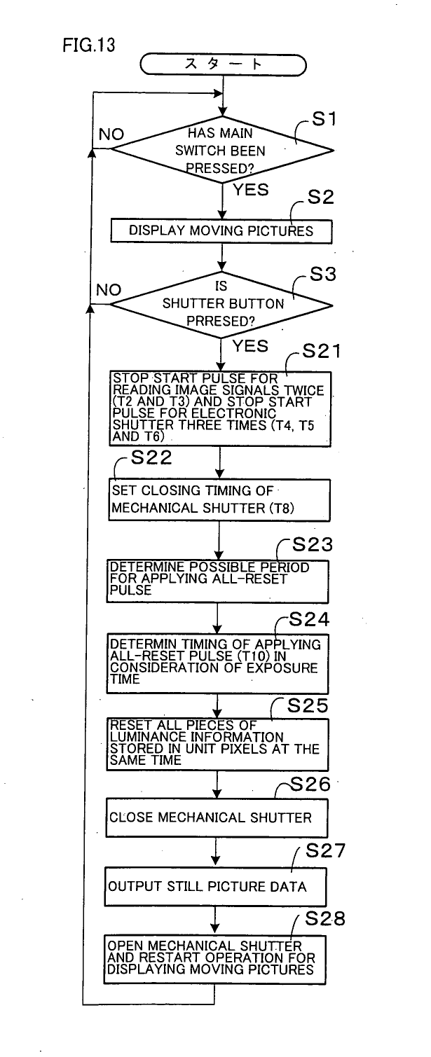

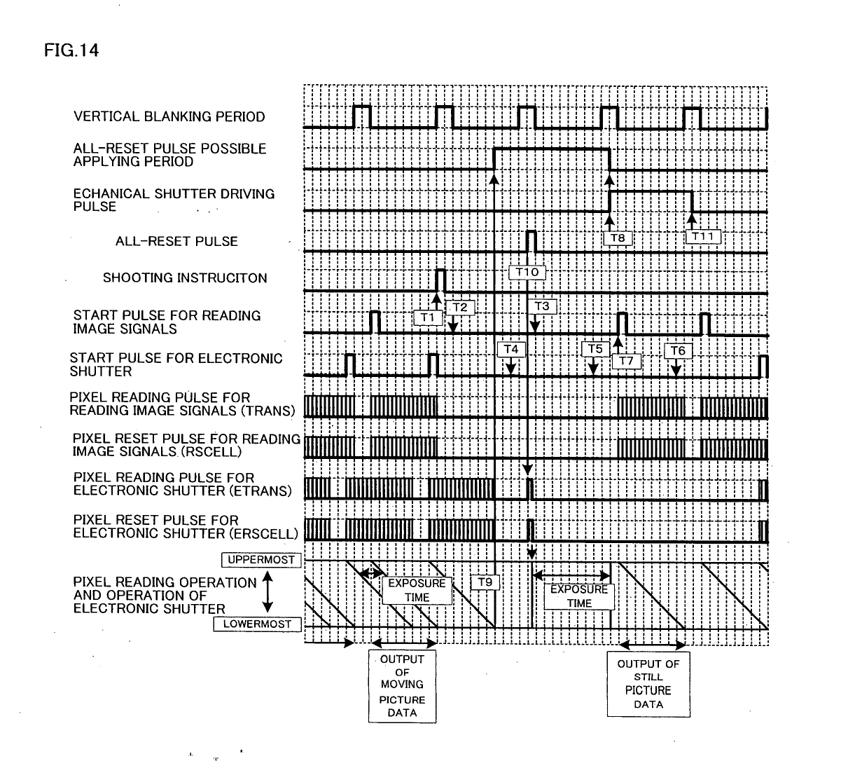

FIG. 13 shows the processing procedure performed to take a still picture according to the first modification of the present invention. FIG. 14 is a timing chart for control pulses and so on according to the first modification.

The following describe the processing procedure performed to take a still picture, with reference to FIG. 13 and FIG. 14.

Note that the same steps as the first embodiment are numbered in the same manner, and such steps are not described here.

(1) to (3): The same as (1) to (3) of the first embodiment (Steps 1 to 3).

(4) If the shutter button is pressed by the user, the receiving unit 103 instructs the monitor unit 102 to stop operations for the display of moving pictures. The monitor unit 102 stops the start pulse used for reading image signals twice (T2 and T3) after the shutter button is pressed, and then stops the start pulse used for the electronic shutter three times (T4, T5 and T6) (Step S21).

(5) The receiving unit 103 sets T8 as a time at which the mechanical shutter is closed. T8 is a little before T7 at which the start pulse used for reading image signals is restarted (Step S22).

(6) The receiving unit 103 sets T9 as a possible start point of the application of the all-reset pulse. At T7, the mechanical shutter finishes the operation in accordance with the start pulse used for the electronic shutter. Then, the receiving unit 103 sets T8 as a possible end point of the application of the all-reset pulse. At T8, the mechanical shutter is closed (Step S23).

(7) The receiving unit 103 determines the application timing of the all-reset pulse (T10) based on the possible end point, with consideration of the exposure time (Step S24).

(8) The all-reset unit 104 applies the all-reset pulse at T10 in accordance with the decision by the receiving unit 103, to reset all the pieces of the luminance information stored in the unit cells at the same time (Step S25).

(9) The drive control unit 30 applies the mechanical shutter driving pulse at T8 in accordance with the decision by the receiving unit 103, and the light-shielding unit 101 closes the mechanical shutter (Step S26).

(10) The drive control unit 30 applies the start pulse used for reading image signals at T7, and still picture data is output (Step S27).

(11) As the still picture data is output, the drive control unit 30 stops the mechanical shutter driving pulse (T11). Accordingly, the light-shielding unit 101 opens the mechanical shutter. Then, the operation for displaying moving pictures is restarted (Step S28).

<Summary>

As described above, in the first modification of the present invention, the exposure time for still picture shooting is longer than that in the first embodiment. This is because the period, in which the operations for displaying moving pictures is stopped for shooting a still picture, is for three frames in the first modification, whereas it is for two frames in the first embodiment. Accordingly, for instance, it becomes possible to choose a narrow aperture, and this gives a lot of options to the user at the picture shooting.

Note that the length of the period for stopping the operations is not limited to three-frame long. The advantageous effect of the present invention can be obtained regardless of the length (number of frames) of the period.

The Second Modification

<Overview>

The second modification of the present invention describes operations by which moving pictures are recorded using a pixel-skipping mode which reduces the number of pixels, and still pictures are recorded using a full-scan mode which uses all the pixels.

<Operations>

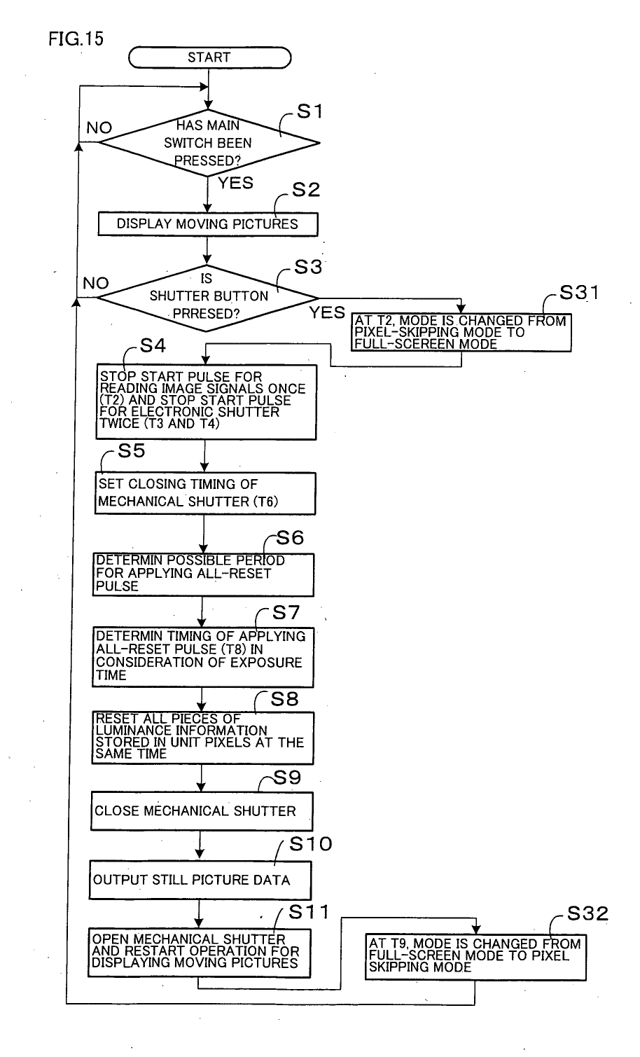

FIG. 15 shows a processing procedure performed to take a still picture according to the second modification.

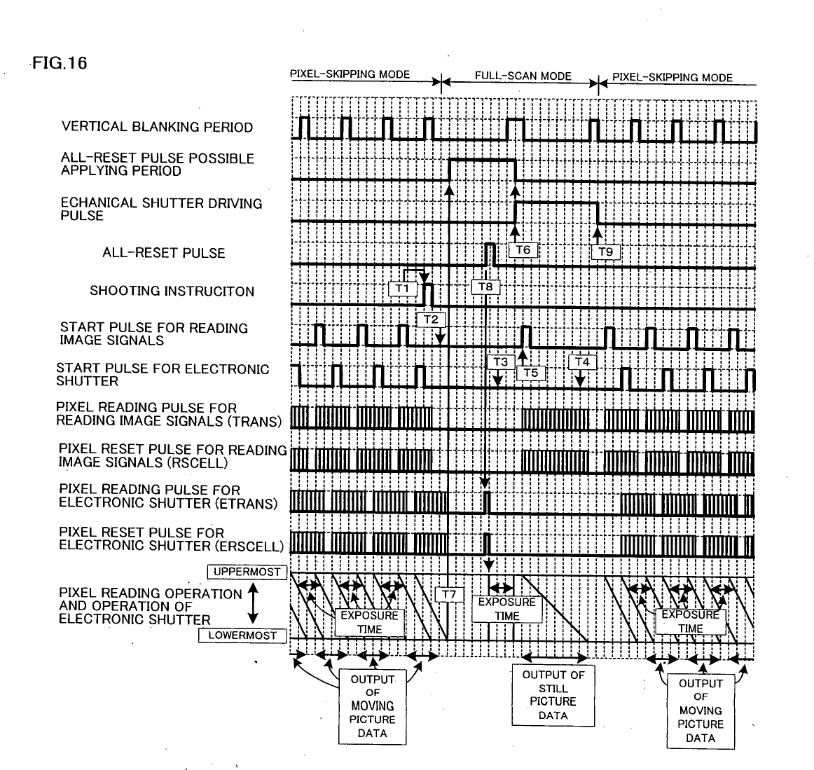

FIG. 16 is a timing chart for control pulses and so on according to the second modification.

Note that the same steps as the first embodiment are numbered in the same manner, and such steps are not described here.

(1) to (3): The same as (1) to (3) of the first embodiment (Steps 1 to 3).

Here, the moving pictures are displayed in the pixel-skipping mode, and the reading period is reduced toe approximately a half.

(4) The same as (4) of the first embodiment (Step S4).

(5) At T2, the mode is changed from the pixel-skipping mode to the full-scan mode (Step S31).

(6) to (12): The same as (5) to (11) of the first embodiment (Steps S5 to S11).

(13) At T9, the mode is changed from the full-scan mode to the pixel-skipping mode (Step S32).

<Summary>

In the same manner as the first embodiment, according to the second modification, high-quality images can be obtained especially in the case of the still picture shooting, even in the case where one of the pixel-skipping mode and the full-scan mode is chosen based on the purpose. For instance, it becomes possible to obtain high-resolution still pictures.

Note that the pixel skipping in the pixel-skipping mode does not necessarily reduce the number of pixels to approximately a quarter of the original and shorten the length of the period to approximately a half of the original. The advantageous effect of the present invention can be obtained regardless of the number of the pixels and the length of the period.

The Third Modification

<Overview>

In the third modification of the present invention, the all-reset pulse is applied out of the horizontal blanking period for moving pictures. Accordingly, the all-reset pulse can be applied more freely in view of the timing, compared to the first embodiment.

<Operations>

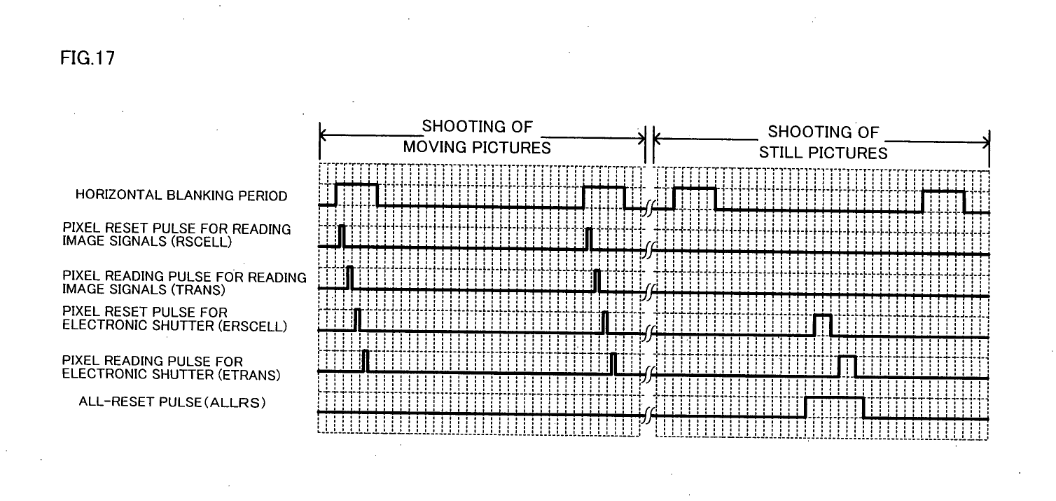

FIG. 17 is a timing chart for the all-reset pulse and so on according to the third modification.

As FIG. 17 shows, the all-reset pulse is applied at a time out of the horizontal blanking period. Accordingly, it becomes possible to drive the electronic shutter at any time out of the horizontal blanking period.

<Summary>

As described above, the all-reset pulse can be applied more freely in view of the timing, compared to the first embodiment.

Note that the present invention may be a combination among any of the first embodiment and the first to third modifications. Also, the present invention may include functions of any of the first embodiment and the first to third modifications as switchable functions.

### INDUSTRIAL APPLICABILITY

The present invention is applicable to imaging apparatuses such as video cameras and digital still cameras. Although not reading luminance information from all the unit cells at the same time, the solid-state imaging device according to the present invention is capable of completely eliminating the distortion of the image caused by the difference of exposure timing. Also the present invention contributes to improve the quality of the image taken by imaging devices with reduced power consumption. Therefore, the present invention has a great deal of potential in industry.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An imaging device having a plurality of unit cells, each generating and accumulating therein a piece of luminance information in accordance with an amount of received light, the imaging device comprising:
a receiving unit operable to receive a shooting instruction from outside;
an all-reset unit operable to simultaneously reset all the unit cells in response to the shooting instruction while a light-shielding gate is open;
a light-shielding unit operable to close the light-shielding gate to simultaneously block light incident on all the unit cells when, after the all-reset unit resets all the unit cells, a total length of periods for which the light-shielding gate has been open reaches an exposure time; and
a reading unit operable to sequentially read pieces of the luminance information from all the unit cells while the light-shielding gate is closed.

2. The imaging device of claim 1, wherein
the light-shielding unit closes the light-shielding gate at a time determined independently of a change of the exposure time, and
the all-reset unit adjusts a timing with which the all-reset unit resets all the unit cells, in accordance with the change of the exposure time.

3. The imaging device of claim 1 further comprising:
a monitor unit operable, before the shooting instruction is received by the receiving unit, to display moving pictures by continuously reading the pieces of the luminance information while the light-shielding gate is open, and when the shooting instruction is received, to stop a pixel reset operation and a luminance information reading operation, which are performed every time the luminance information is read, at least until the reading unit finishes reading the pieces of the luminance information.

4. The imaging device of claim 3, wherein
the monitor unit applies a pixel reset signal and a luminance information reading signal to read the pieces of the luminance information, and stops applying the pixel reset signal and the luminance information reading signal at least during a period between when the all-reset unit resets all the unit cells and when the light-shielding unit blocks the light.

5. The imaging device of claim 4, wherein
the monitor unit includes a shift register operable to sequentially generate the pixel reset signal and the luminance information reading signal for each column of the imaging device, and stops an operation of the shift register at least during the period between when the all-reset unit resets all the unit cells and when the light-shielding unit blocks the light.

6. The imaging device of claim 5, wherein
the shift register sequentially generates the pixel reset signal and the luminance information reading signal for each column of the imaging device while sequentially shifting a target column to which a start pulse is provided for each frame, and
the monitor unit stops the start pulse in response to the shooting instruction at least until when the light-shielding unit blocks the light.

7. The imaging device of claim 5, wherein
the all-reset unit simultaneously resets all the unit cells in a period between when the shift register finishes generating the pixel reset signal and the luminance information reading signal for each column and when the light-shielding unit blocks the light.

8. The imaging device of claim 3, wherein
to read the pieces of the luminance information, the monitor unit applies a first pixel reset pulse used for an electronic shutter, a first pixel reading pulse used for the electronic shutter, a second pixel reset pulse used for reading image signals and a second pixel reading pulse used for reading image signals, and stops applying the first pixel reading pulse and the second pixel reading pulse at least during a period between when the all-reset unit resets all the unit cells and when the light-shielding unit blocks the light.

9. The imaging device of claim 3, wherein
to read the pieces of the luminance information, the monitor unit applies a first pixel reset pulse used for an electronic shutter, a first pixel reading pulse used for the electronic shutter, a second pixel reset pulse used for reading image signals and a second pixel reading pulse used for reading image signals, and stops applying the first pixel reset pulse, the first pixel reading pulse, the second pixel reset pulse and the second pixel reading pulse at least during a period between when the all-reset unit resets all the unit cells and when the light-shielding unit blocks the light.

10. The imaging device of claim 3, wherein
to read the pieces of the luminance information, the monitor unit applies a pixel reset pulse used for an electronic shutter and a pixel reading pulse used for the electronic shutter, and stops applying the pixel reading pulse during a period between when the all-reset unit resets all the unit cells and when the reading unit finishes reading the pieces of the luminance information.

11. The imaging device of claim 3, wherein
to read the pieces of the luminance information, the monitor unit applies a pixel reset pulse used for an electronic shutter and a pixel reading pulse used for the electronic shutter, and stops applying the pixel reset pulse and the pixel reading pulse during a period between when the all-reset unit resets all the unit cells and when the reading unit finishes reading the pieces of the luminance information.

12. The imaging device of claim 3, wherein
the monitor unit includes a shift register operable to sequentially generate the pixel reset signal for each column of the imaging device, and stops an operation of the shift register during a period between when the all-reset unit resets all the unit cells and when the reading unit finishes reading the pieces of the luminance information.

13. The imaging device of claim 12, wherein
the shift register sequentially generates the pixel reset signal for each column of the imaging device while sequentially shifting a target column to which a start pulse is provided for each frame, and
the monitor unit stops the start pulse in response to the shooting instruction until the reading unit finishes reading the pieces of the luminance information.

14. The imaging device of claim 12, wherein
the imaging device further comprises:
a unit cell driving circuit operable to generate a pulse used for driving the unit cells, based on a signal provided by the all-reset unit to reset all the unit cells and a signal provided by the monitor unit to perform the pixel reset operation, and provide each of the unit cells with the generated pulse, and
each of the shift register and the selection circuit is structured by a dynamic circuit using a single channel MOS.

15. The imaging device of claim 1, wherein
the all-reset unit resets all the unit cells at any time in one cycle of a horizontal scanning, regardless of whether the time is within a horizontal blanking period.

16. A driving device that provides control signals to an imaging device having a plurality of unit cells, each outputting a piece of luminance information in accordance with an amount of received light, the driving device comprising:
a waiting unit operable to wait for a shooting instruction to be input from outside;
an all-reset control signal outputting unit operable to output an all-reset control signal to simultaneously reset all the unit cells in response to the shooting instruction while a light-shielding gate is open;
a closing control signal outputting unit operable to output a light-shielding gate closing control signal to close the light-shielding gate that blocks light incident on all the unit cells when, after the all-reset unit resets all the unit cells, a total length of periods for which the light-shielding gate has been open reaches an exposure time; and
a reading control signal outputting unit operable to output a reading control signal to sequentially read the pieces of the luminance information from all the unit cells while the light-shielding gate is closed.

17. An imaging method for controlling an imaging device having a plurality of unit cells, each outputting a piece of luminance information in accordance with an amount of received light, the imaging method comprising:
a receiving step of receiving a shooting instruction from outside;
an all-reset step of simultaneously resetting all the unit cells in response to the shooting instruction while a light-shielding gate is open;
a light-shielding step of closing the light-shielding gate to simultaneously block light incident on all the unit cells when, after the all-reset unit resets all the unit cells, a total length of periods for which the light-shielding gate has been open reaches an exposure time; and
a reading step of sequentially reading pieces of the luminance information from all the unit cells while the light-shielding gate is closed.
